(19) United States
(12) Patent Application Publication
(10) Pub. No.: US 2026/0051957 A1
(43) Pub. Date: Feb. 19, 2026

(54) Optical Interconnects

(71) Applicant: Artilux, Inc., Menlo Park, CA (US)

(72) Inventor: Neil Y. NA, Zhubei City (TW)

(21) Appl. No.: 19/299,492

(22) Filed: Aug. 14, 2025

Related U.S. Application Data
(60) Provisional application No. 63/683,253, filed on Aug. 15, 2024.

(51) Int. Cl. H04B 10/516; H04B 10/25; H04B 10/61; H04B 10/80

(52) U.S. Cl. CPC H04B 10/5161; H04B 10/25; H04B 10/61; H04B 10/801

(57) ABSTRACT

An optical interconnect includes a transmitter unit and a receiver unit. The transmitter unit includes a laser device configured to generate a source optical signal; a modulator unit configured to modulate the source optical signal and to generate a modulated optical signal having an in-phase component and a quadrature component; and a first optical coupler configured to couple a transmitted optical signal having the modulated optical signal, where the source optical signal and the modulated optical signal propagate in-plane along a surface of the transmitter unit, and where the transmitted optical signal propagates out-of-plane from the surface of the transmitter unit. The receiver unit includes a second optical coupler to couple the transmitted optical signal into the receiver unit; and a demodulator unit to receive the transmitted optical signal and a reference optical signal, and generate a demodulated electrical signal having the in-phase and the quadrature components.

### RELATED APPLICATION

The subject application claims the benefit of priority to U.S. Provisional Patent Application No. 63/683,253 filed on Aug. 15, 2024, titled “Optical Interconnects,” which is incorporated by reference herein in its entirety for all purposes.

### TECHNICAL FIELD

This application relates to implementations of optical interconnects for high-speed communications.

### BACKGROUND

High-performance computing applications such as neural network model trainings or inferences for artificial intelligence (AI) applications require high bandwidth communications among various computing elements and/or memory elements. As an example, certain computing elements such as graphics processing units (GPU) require intense parallelism, and moving massive data off and between chips can be the bottleneck of the computing performance and energy efficiency. Optical interconnects (or optical links) offer significant advantages in such high-performance computing applications. One of the primary benefits is the high bandwidth that optical interconnects provide, enabling much faster data transfer rates compared to electrical interconnects. This is critical in neural networks, where vast amounts of data must be processed and transmitted between nodes rapidly. Additionally, optical communication can significantly reduce latency, which is vital for the performance of real-time processing tasks in robotics or edge computing. Another major advantage of optical interconnects is energy efficiency. They consume less power than electrical interconnects, particularly over long distances. Lastly, optical signals are immune to electromagnetic interference and crosstalk, leading to reduced signal degradation and more reliable data transmission for maintaining the accuracy of high-performance computations.

### SUMMARY

Aspects and advantages of embodiments of the present disclosure will be set forth in part in the following description, or may be learned from the description, or may be learned through practice of the embodiments.

One example aspect of the present disclosure is directed to an optical interconnect that includes a transmitter unit and a receiver unit. The transmitter unit includes a laser device configured to generate a source optical signal, a modulator unit configured to modulate the source optical signal and to generate a modulated optical signal having an in-phase component and a quadrature component, and a first optical coupler configured to couple a transmitted optical signal having the modulated optical signal out of the transmitter unit. The source optical signal and the modulated optical signal propagate in-plane along a surface of the transmitter unit, and the transmitted optical signal propagates out-of-plane from the surface of the transmitter unit. The receiver unit includes a second optical coupler configured to couple the transmitted optical signal into the receiver unit, and a demodulator unit configured to receive the transmitted optical signal and a reference optical signal and generate a demodulated electrical signal having the in-phase component and the quadrature component.

In some implementations, the transmitter unit may further include a first digital signal processor configured to receive one or more input data signals and to generate one or more DSP signals representing the in-phase component and the quadrature component; and one or more first digital-to-analog converters configured to receive the one or more DSP signals from the first digital signal processor and to generate one or more analog control signals for driving the modulator unit.

In some implementations, the receiver unit may further include one or more first analog-to-digital converters configured to receive the demodulated electrical signals and to generate one or more demodulated digital signals; and a second digital signal processor configured to receive the one or more demodulated digital signals and to generate one or more output data signals representing the one or more input data signals.

In some implementations, the modulator unit may include nested Mach-Zehnder interferometers and a quadrature phase-shifter. In some other implementations, the modulator unit may include nested ring modulators and a quadrature phase-shifter.

In some implementations, the first optical coupler and the second optical coupler may include optical grating couplers, where the transmitted optical signal propagates out-of-plane from the surface of the transmitter unit at a substantially normal direction from the surface of the transmitter unit.

In some implementations, the transmitter unit may further include a second modulator unit configured to modulate the source optical signal and to generate a second modulated optical signal having a second in-phase component and a second quadrature component, where the transmitted optical signal further includes the second modulated optical signal. The receiver unit may further include a second demodulator unit configured to receive the transmitted optical signal and the reference optical signal and generate a second demodulated electrical signal having the second in-phase component and the second quadrature component.

In some implementations, the first optical coupler and the second optical coupler may include latticed grating couplers having two inputs.

In some implementations, the reference optical signal may be generated by the receiver unit. In some other implementations, the reference optical signal may be generated by the transmitter unit.

In some implementations, the modulated optical signal may represent a phase-shift-keying (PSK) modulated signal. In some other implementations, the modulated optical signal may represent a quadrature amplitude modulation (QAM) modulated signal.

In some implementations, the optical interconnect may include an optical cable that is optically coupled to the first optical coupler of the transmitter unit and the second optical coupler of the receiver unit. The optical cable may include one or more single-mode fibers or one or more polarization maintaining fibers. In some implementations, one end of the optical cable may be co-packaged with the transmitter unit via a first fiber array having multiple fibers, and another end of the optical cable may be co-packaged with the receiver unit via a second fiber array having multiple fibers.

In some implementations, the modulator unit and the first optical coupler may be integrated in a silicon substrate. In some implementations, the laser device may be bonded to the silicon substrate.

Another example aspect of the present disclosure is directed to a computing system that includes a first processor element, a second processor element, and an optical interconnect configured to provide data communications between the first processor element and the second processor element. The optical interconnect includes a transmitter unit and a receiver unit. The transmitter unit includes a laser device configured to generate a source optical signal, a modulator unit configured to modulate the source optical signal and to generate a modulated optical signal having an in-phase component and a quadrature component, and a first optical coupler configured to couple a transmitted optical signal having the modulated optical signal out of the transmitter unit. The source optical signal and the modulated optical signal propagate in-plane along a surface of the transmitter unit, and the transmitted optical signal propagates out-of-plane from the surface of the transmitter unit. The receiver unit includes a second optical coupler configured to couple the transmitted optical signal into the receiver unit, and a demodulator unit configured to receive the transmitted optical signal and a reference optical signal and generate a demodulated electrical signal having the in-phase component and the quadrature component.

In some implementations, the first processor element, the second processor element, and the optical interconnect may be co-packaged on a common substrate. In some implementations, each of the first processor element and the second processor element may include one or more of a graphics processing unit (GPU), a central processing unit (CPU), a neural network processing unit (NPU), or a tensor processing unit (TPU).

Other example aspects of the present disclosure are directed to systems, methods, apparatuses, sensors, computing devices, tangible non-transitory computer-readable media, and memory devices related to the described technology.

These and other features, aspects and advantages of various embodiments will become better understood with reference to the following description and appended claims. The accompanying drawings, which are incorporated in and constitute a part of this specification, illustrate embodiments of the present disclosure, and together with the description, serve to explain the related principles.

### BRIEF DESCRIPTION OF THE DRAWINGS

The foregoing aspects and many of the advantages of this application will become more readily appreciated as the same becomes better understood by reference to the following detailed description, when taken in conjunction with the accompanying drawings:

FIGS. 1A and 1B show examples of a coherent optical interconnect.

FIGS. 2A and 2B show examples of a coherent optical interconnect.

FIGS. 3A to 3D show examples of a computing system.

Like reference numbers and designations in the various drawings indicate like elements.

### DETAILED DESCRIPTION

The present disclosure describes optical interconnects implemented based on photonics integrated circuit. In general, pluggable optical interconnects that are edge-coupled to an external medium (e.g., an optical fiber or an optical fiber array) may have limited achievable data rate per interface, higher packaging costs (e.g., complex optical alignment for edge-coupled devices), and higher testing cost (e.g., wafer-level testing is not possible for edge-coupled devices). For highly parallel computing architectures, there are technical advantages for implementing optical interconnects that can be vertically coupled off-chip to an external medium, so to achieve high performance, better area efficiency, and low cost. Moreover, optical interconnects implemented using a coherent scheme based on photonics integrated circuit further increases overall transmission bandwidth per channel. A coherent scheme uses both the amplitude and phase (and in some cases, polarization) of light to encode information, which enables higher data rates, longer transmission distances, and better spectral efficiency. Lastly, in addition to pluggable optical interconnects, optical interconnects can be co-packaged to be closer to the computing elements, in order to improve the bandwidth density and energy efficiency for data link without incurring substantial energy cost.

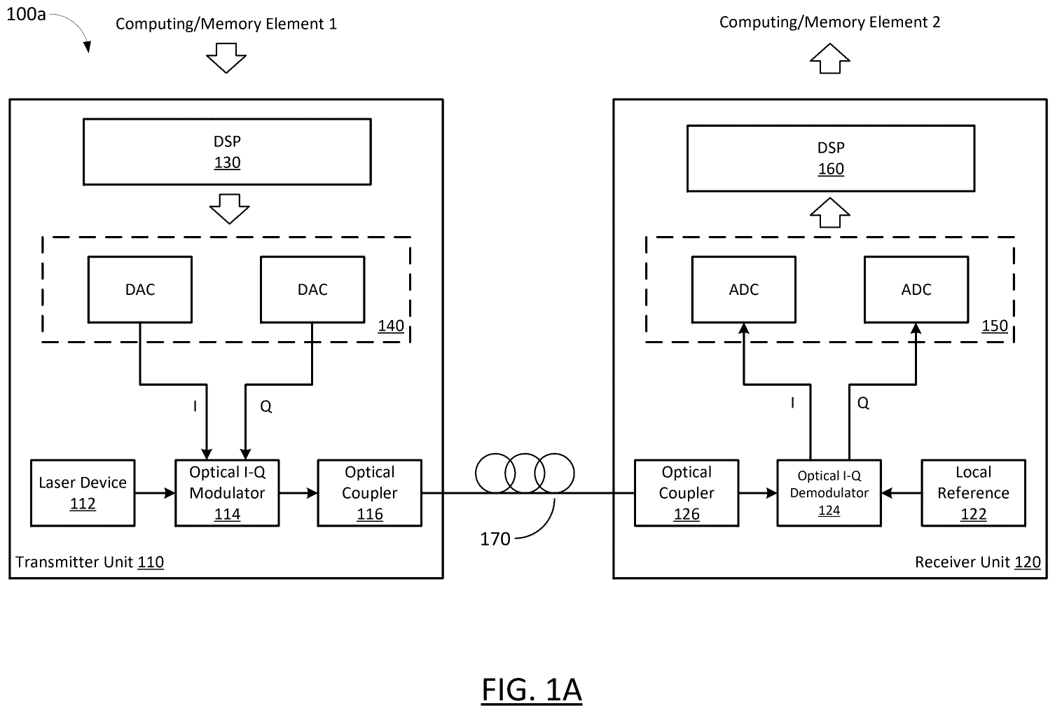

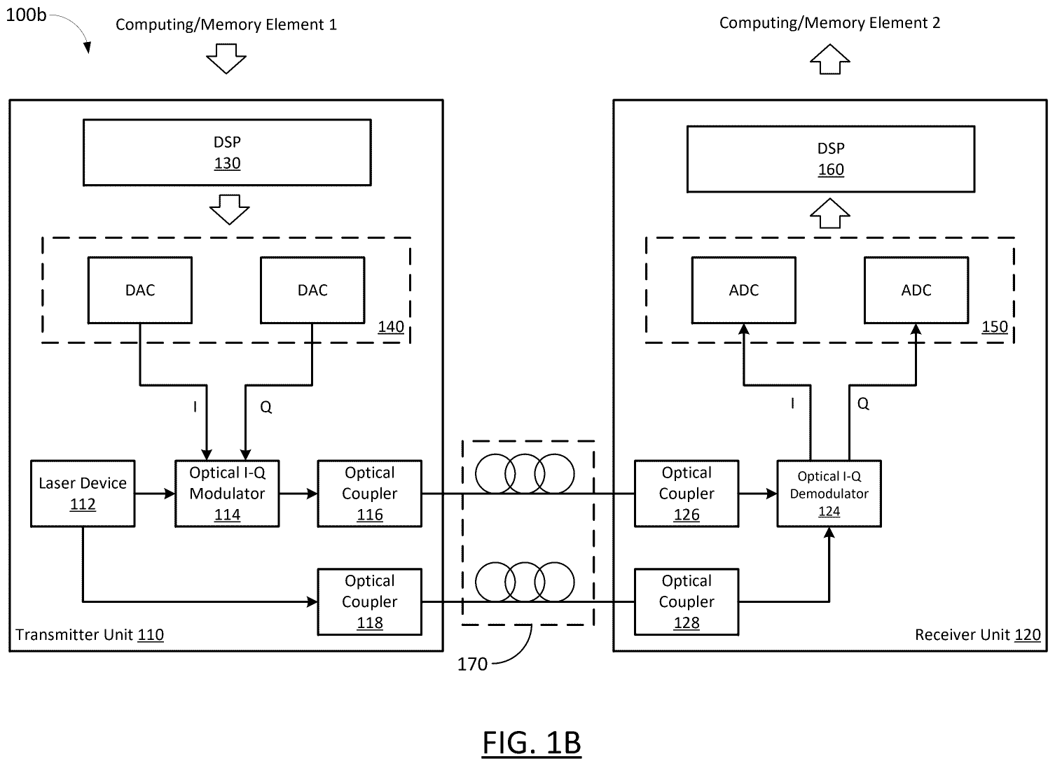

FIG. 1A shows an example coherent optical interconnect 100a. The coherent optical interconnect 100a includes a transmitter unit 110 and, an optical cable 170, and a receiver unit 120, where the coherent optical interconnect 100a transports data between two or more computing/memory elements. Each of the computing/memory elements can include one or more of a graphics processing unit (GPU), a central processing unit (CPU), a neural network processing unit (NPU), a tensor processing unit (TPU), a memory (e.g., high bandwidth memory, random access memory, etc.), or a combination thereof. The transported data may be modulated using a coherent modulation scheme such as a phase-shift-keying (PSK) modulation or a quadrature amplitude modulation (QAM) modulated signal, depending on the required effective data rate.

The transmitter unit 110 includes a first digital signal processor (DSP) 130 configured to receive one or more input data signals from a computing/memory element, and to generate one or more DSP signals representing the in-phase component (the “I” component) and the quadrature component (the “Q” component) of encoded symbols. The transmitter unit 110 further includes one or more first digital-to-analog converters (DAC) 140 configured to receive the one or more DSP signals from the first DSP 130 and to generate one or more analog control signals for driving an optical I-Q modulator 114 (or a modulator unit, used interchangeably with the term “optical I-Q modulator”). The DSP 130 and the DAC 140 may be implemented on different chips or on the same chip.

The transmitter unit 110 further includes a laser device 112 configured to generate a source optical signal. In some implementations, the laser device 112 may be modulated at a reference frequency and amplitude. In some implementations, the laser device 112 may be integrated with a photonic integrated circuit. For example, the laser device 112 may be bonded to a silicon substrate (e.g., III-V lasers hybrid-bonded to a silicon waveguide formed in a silicon-on-insulator (SOI) substrate). In some other implementations, the laser device 112 may be an external laser source that couples optical signals to the photonic integrated circuit via an external medium (e.g., an optical fiber).

The transmitter unit 110 further includes an optical I-Q modulator 114 configured to modulate the source optical signal and to generate a modulated optical signal having the in-phase component and quadrature component. In some implementations, the optical I-Q modulator 114 may be implemented using nested Mach-Zehnder interferometers (MZI) and a quadrature phase-shifter arranged to perform I-Q modulations. In some other implementations, the optical I-Q modulator 114 may be implemented using nested ring modulators and a quadrature phase-shifter arranged to perform I-Q modulations. The one or more analog control signals generated by the first DAC 140 are used to drive the optical I-Q modulator 114 (e.g., control the phase changes along different MZI arms, or rings, etc.).

The transmitter unit 110 further includes a first optical coupler 116 configured to couple a transmitted optical signal having the modulated optical signal out of the transmitter unit 110. In some implementations, the optical I-Q modulator 114 and the first optical coupler 116 may be integrated in a silicon substrate (e.g., silicon waveguides and grating couplers formed in a silicon-on-insulator (SOI) substrate) or a suitable semiconductor or III-V-materials substrate, where the source optical signal and the modulated optical signal propagate in-plane along a surface of the transmitter unit 110. In some implementations, the first optical coupler 116 may be formed as an optical grating coupler, where the transmitted optical signal propagates out-of-plane (e.g., substantially normal from the chip surface) from the surface of the transmitter unit 110 to enable easier packaging and optical alignment.

The receiver unit 120 includes a second optical coupler 126 configured to couple the transmitted optical signal into the receiver unit 120. The receiver unit 120 further includes an optical I-Q demodulator 124 (or a demodulator unit, used interchangeably with the term “optical I-Q demodulator”) configured to receive the transmitted optical signal and a reference optical signal, and to generate a demodulated electrical signal comprising the in-phase component and/or the quadrature component. In some implementations, the optical I-Q demodulator 124 may be implemented using nested 3-dB couplers, a quadrature phase-shifter, and photo-detectors. The second optical coupler 126 and the optical I-Q demodulator 124 may be integrated in a silicon substrate or a suitable semiconductor or III-V-materials substrate.

In some implementations, the reference optical signal may be generated by the receiver unit 120. Referring to FIG. 1A as an example, the reference optical signal may be generated by a local reference 122 that is synchronized in phase with the laser device 112. In some other implementations, if the distance between the transmitter unit 110 and the receiver unit 120 is short (e.g., chip-to-chip or blade-to-blade transmission), the reference optical signal may be generated by the transmitter unit 110. Referring to FIG. 1B as an example, the reference optical signal may be generated by the laser device 112 and transmitted to the receiver unit 120 via optical couplers 118 and 128.

The receiver unit 120 further includes one or more first analog-to-digital converters (ADC) 150 configured to receive the demodulated electrical signals and to generate one or more demodulated digital signals. The receiver unit 120 further includes a second digital signal processor (DSP) 160 configured to receive the one or more demodulated digital signals and to generate one or more output data signals representing the one or more input data signals to the second computing/memory element. The DSP 160 and the ADC 150 may be implemented on different chips or on the same chip.

The optical cable 170 is optically coupled to the transmitter unit 110 and the receiver unit 120, where one end of the optical cable 170 may be co-packaged with the transmitter unit 110 via a first fiber array having one or multiple fibers, and the other end of the optical cable 170 may be co-packaged with the receiver unit 120 via a second fiber array having one or multiple fibers. In some implementations, the optical cable 170 includes one or more single-mode fibers. In some other implementations, the optical cable 170 includes one or more polarization maintaining fibers.

In some implementations, each of the optical couplers 116/118/126/128 may be a 1-D grating coupler having one input. In some other implementations, the optical couplers 116/118/126/128 may be latticed grating couplers having two inputs. A latticed grating coupler is a 2-D grating coupler formed by superimposing two 1-D grating couplers oriented at orthogonal directions (e.g., a first 1-D grating along the x-direction, and a second 1-D grating along the y-direction). Such latticed grating couplers allow two optical signals to be transmitted in parallel in a single optical fiber having two orthogonal propagation axes (e.g., a fast axis and a slow axis), and therefore doubling the data rate.

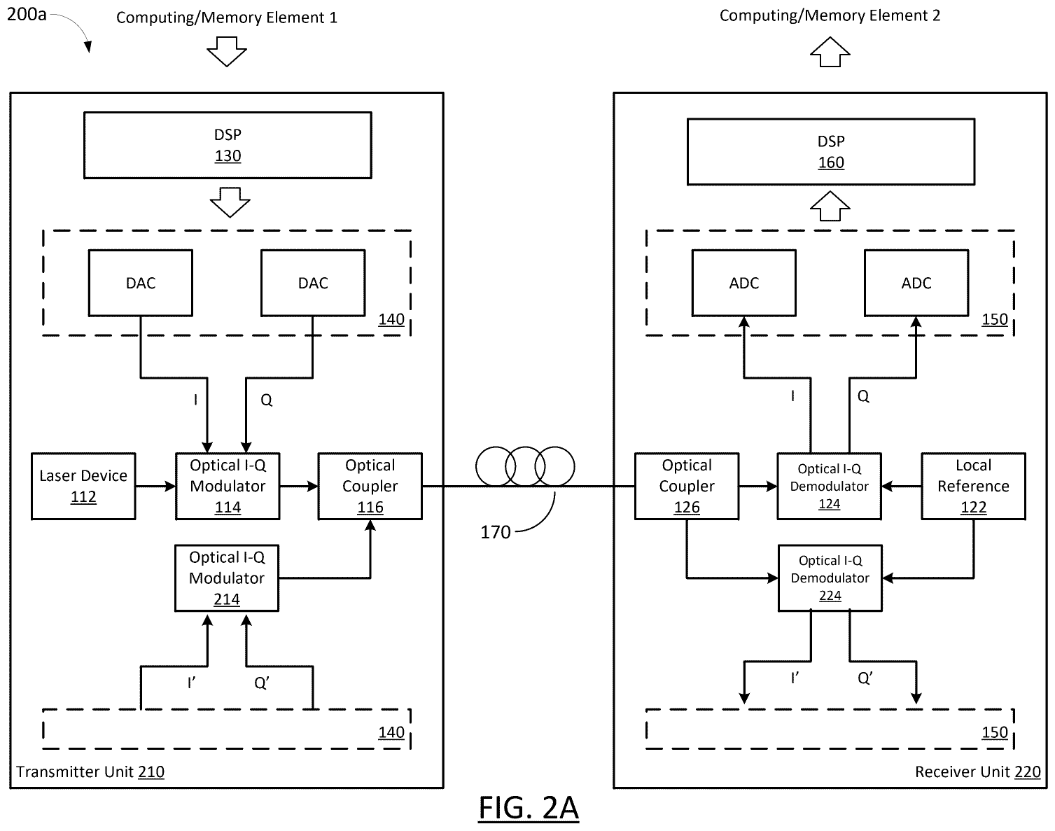

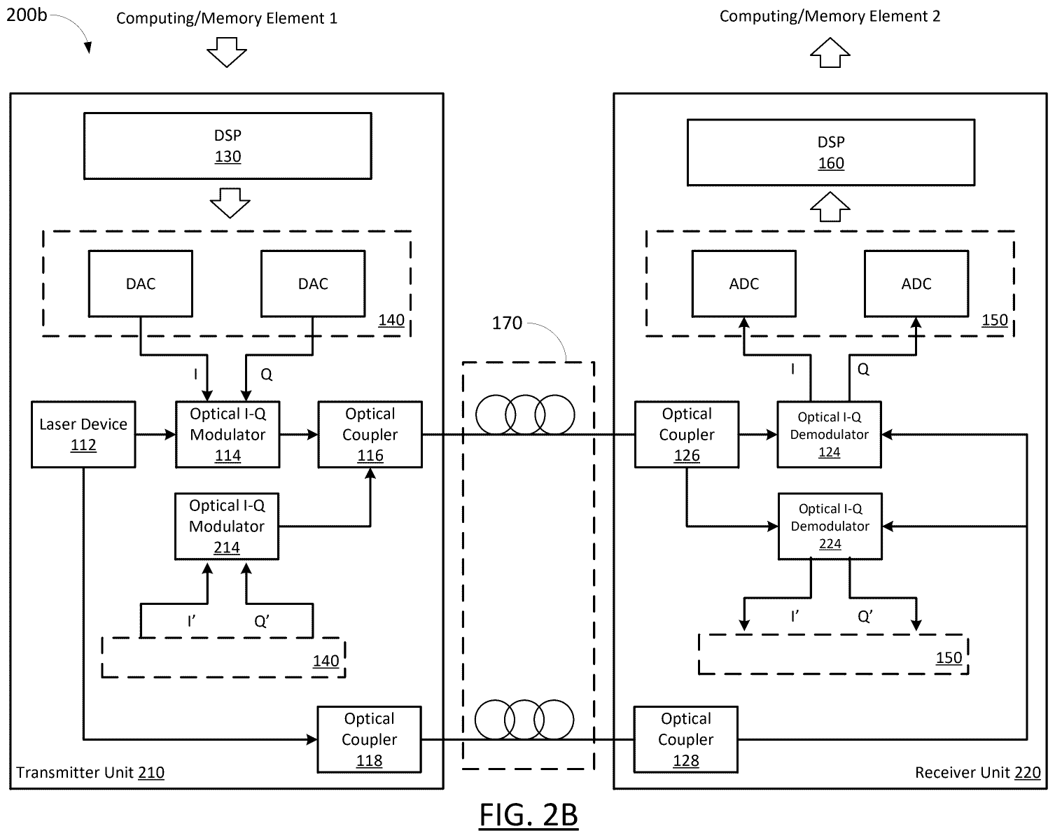

Referring to FIG. 2A as an example, the transmitter unit 210 is similar to the transmitter unit 110 as described in reference to FIGS. 1A/1B, and further includes a second optical I-Q modulator 214 configured to modulate the source optical signal and to generate a second modulated optical signal including a second in-phase component (I′) and a second quadrature component (Q′). The first modulated optical signal from the first optical I-Q modulator 114 is coupled to a first input of the first optical coupler 116 (a latticed grating coupler), and the second modulated optical signal from the second optical I-Q modulator 214 is coupled to a second input of the first optical coupler 116 that is orthogonal to the first input. The optical cable 170 is aligned with the transmitter unit 210 such that the first modulated optical signal propagates along one optical axis of a fiber in the optical cable 170, and the second modulated optical signal may propagate along an orthogonal optical axis of the same fiber in the optical cable 170.

The receiver unit 220 is similar to the receiver unit 120 as described in reference to FIGS. 1A/1B, and further includes a second optical I-Q demodulator 224. Here, the second optical coupler 126 may be a latticed grating coupler that receives the transmitted optical signal from the optical cable 170, and splits the first modulated optical signal and the second modulated optical signal to the first optical I-Q demodulator 124 and the second optical I-Q demodulator 224, respectively. The first optical I-Q demodulator 124 is configured to receive the first modulated optical signal and the reference optical signal, and to generate a first demodulated electrical signal having the first in-phase component (I) and/or the first quadrature component (Q). The second optical I-Q demodulator 224 is configured to receive the second modulated optical signal and the reference optical signal, and to generate a second demodulated electrical signal having the second in-phase component (I′) and/or the second quadrature component (Q′). One or more of the first in-phase component (I), the first quadrature component (Q), the second in-phase component (I′), and/or the second quadrature component (Q′) can then be processed by the one or more first ADC 150 and the second digital signal processor 160 to generate the output data for the second computing/memory element.

In some implementations, the reference optical signal may be generated by the receiver unit 220. Referring to FIG. 2A as an example, the reference optical signal may be generated by a local reference 122 that is synchronized in phase with the laser device 112. In some other implementations, if the distance between the transmitter unit 210 and the receiver unit 220 is short (e.g., chip-to-chip or blade-to-blade transmission), the reference optical signal may be generated by the transmitter unit 210. Referring to FIG. 2B as an example, the reference optical signal may be generated by the laser device 112 and transmitted to the receiver unit 220 via optical couplers 118 and 128.

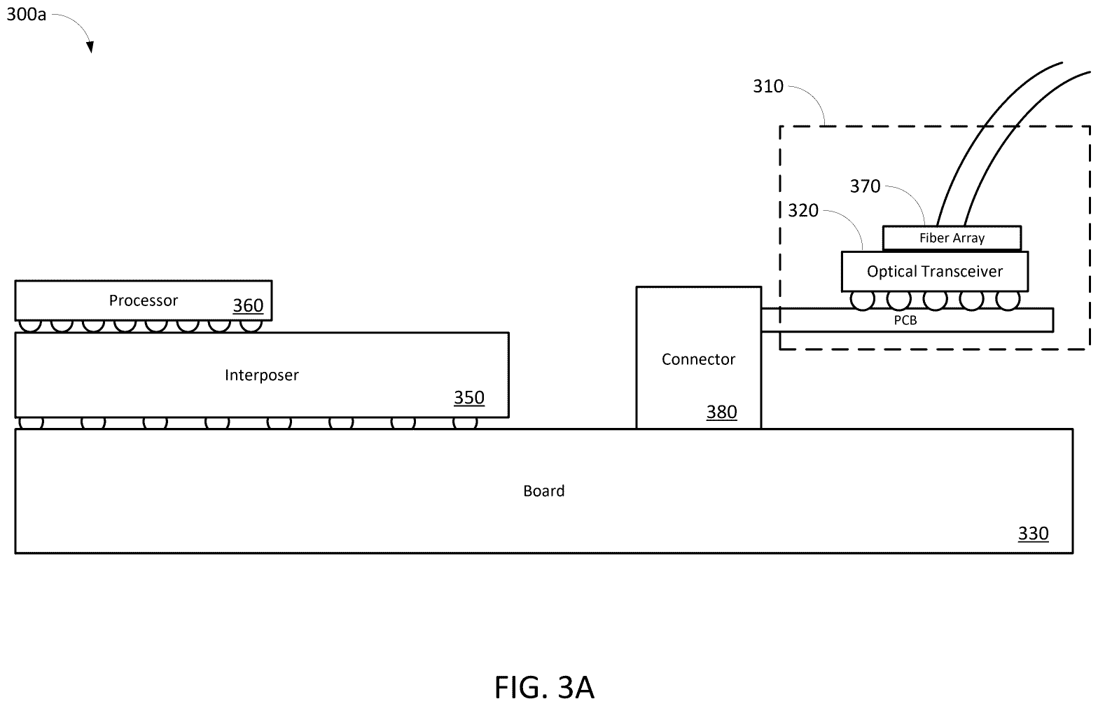

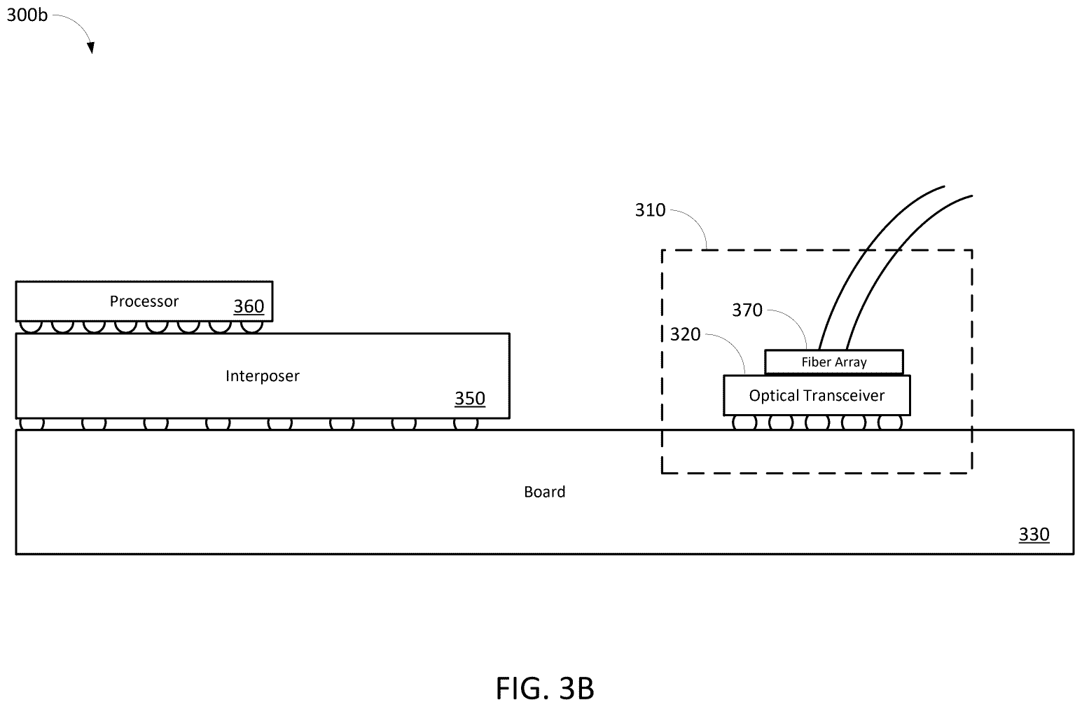

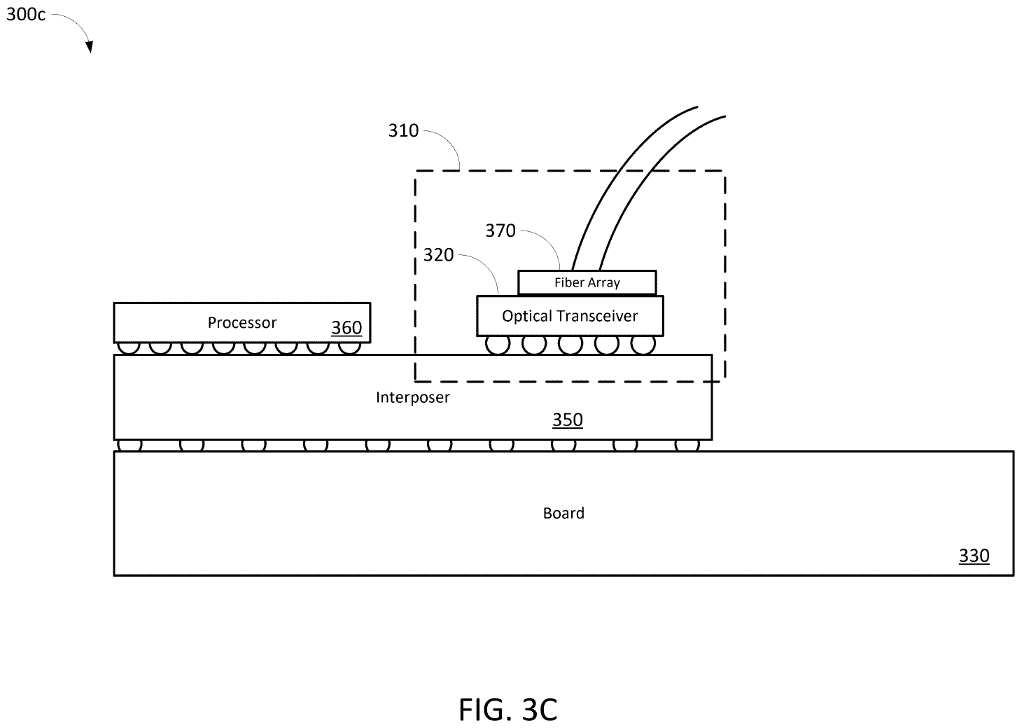

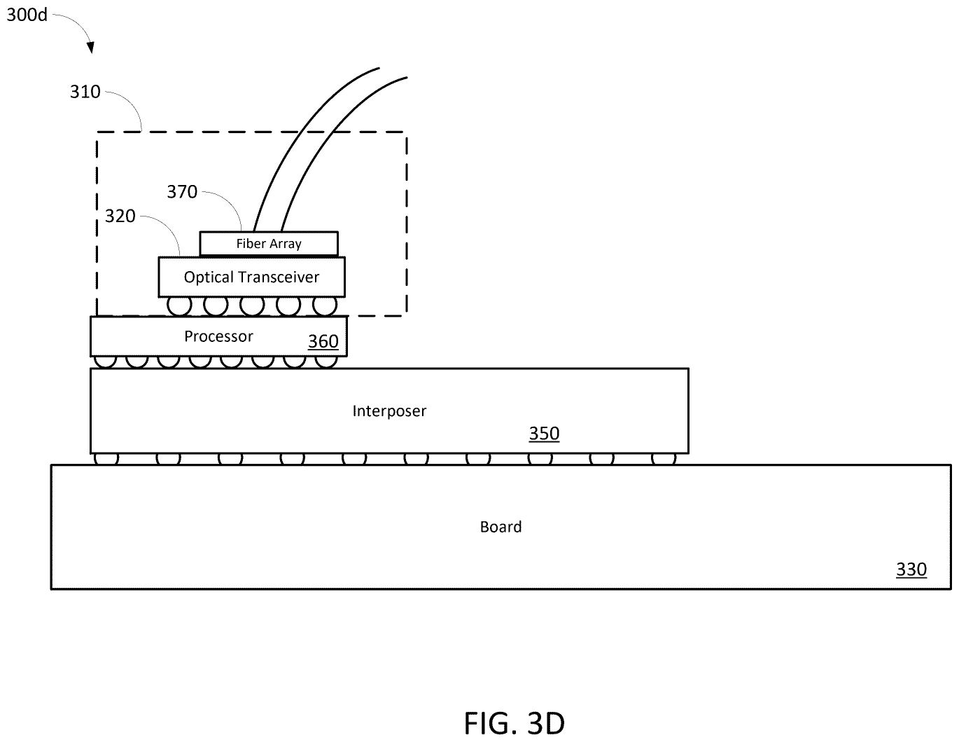

In some implementations, the first computing/memory element, the second computing/memory element, and the coherent optical interconnect (e.g., the coherent optical interconnect 100a/100b/200a/200b) are co-packaged on a common substrate (e.g., PCB substrate, silicon interposer, silicon substrate, or any suitable common substrate, such as the computing system 300b and 300c as described in reference to FIGS. 3B and 3C). In some implementations, the transmitter unit of a coherent optical interconnect is co-packaged with a first computing/memory element, and the receiver unit of the coherent optical interconnect is co-packaged with a second computing/memory element (e.g., the computing system 300d as described in reference to FIG. 3D). For example, the coherent optical interconnect may be co-packaged with two GPUs on the same board to facilitate data communications between the two GPUs. In some implementations, the coherent optical interconnect may be a pluggable active optical cable (AOC) (e.g., the computing system 300a as described in reference to FIG. 3A).

FIG. 3A shows an example of a computing system 300a. The computing system 300a includes an optical link 310, a board 330, an interposer 350, a processor 360, and a connector 380. The computing system 300a may be implemented in a high-performance computing or networking environment such as a data center infrastructure for parallel computing and/or artificial intelligence (AI) applications (e.g., computations for large language model trainings and/or inferences). In general, the board 330 is a circuit board such as a server blade. The interposer 350 is packaged (e.g., bonded) on the board 330, and is a specialized substrate (e.g., a silicon interposer) used in semiconductor packaging (e.g., 2.5D or 3D IC packaging) to facilitate the connection and integration of multiple chips or dies within a single package. The processor 360 is packaged (e.g., bonded) on the interposer 350, and can include one or more of a graphics processing unit (GPU) chip, a central processing unit (CPU) chip, and/or a neural processing unit (NPU) chip. The processor 360 may access data from another computing element (e.g., another processor and/or memory element) externally via the optical link 310.

In general, the optical link 310 includes an optical transceiver 320 (e.g., transmitter unit 110/210 and receiver unit 120/220) and a fiber array unit 370 (e.g., optical cable 170). The optical link 310 may be used for chip-to-chip, module-to-module, package-to-package, board-to-board, or any other suitable type of data communications. In some implementations, if the optical link 310 is a pluggable optical interconnect, the optical link 310 may be packaged as a module with a PCB 390. Referring to FIG. 3A, in some implementations, the optical link 310 may be coupled to the board 330 via a connector 380 (e.g., a QSFP (Quad Small Form-factor Pluggable) connector). in some implementations, the optical link 310 may be packaged (e.g., bonded) on the board 330. Referring to FIG. 3B, in some other implementations, the optical link 310 may be packaged (e.g., bonded) on the board 330. Referring to FIG. 3C, in some other implementations, the optical link 310 may be packaged (e.g., bonded) on the interposer 350. Referring to FIG. 3D, in some other implementations, the optical link 310 may be packaged (e.g., bonded) on the processor 360.

Although only a unidirectional transmitter unit/receiver unit is described here, a coherent optical interconnect can be bidirectional, and/or multi-channel by duplicating the transmitter unit/the receiver unit/number of fibers in a fiber array as needed in a particular application.

As used herein, the terms such as “first”, “second”, “third”, “fourth” and “fifth” describe various elements, components, regions, layers and/or sections, these elements, components, regions, layers and/or sections should not be limited by these terms. These terms may be only used to distinguish one element, component, region, layer or section from another. The terms such as “first”, “second”, “third”, “fourth” and “fifth” when used herein do not imply a sequence or order unless clearly indicated by the context. The terms “photo-detecting”, “photo-sensing”, “light-detecting”, “light-sensing” and any other similar terms can be used interchangeably.

Spatial descriptions, such as “above”, “over,”, “under”, “top”, and “bottom” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated by such arrangement.

As used herein and not otherwise defined, the terms “substantially” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

While the concepts have been described by way of examples and in terms of embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical interconnect, comprising:
a transmitter unit comprising:
a laser device configured to generate a source optical signal;
a modulator unit configured to modulate the source optical signal and to generate a modulated optical signal comprising an in-phase component and a quadrature component; and
a first optical coupler configured to couple a transmitted optical signal comprising the modulated optical signal out of the transmitter unit,
wherein the source optical signal and the modulated optical signal propagate in-plane along a surface of the transmitter unit, and wherein the transmitted optical signal propagates out-of-plane from the surface of the transmitter unit; and
a receiver unit comprising:
a second optical coupler configured to couple the transmitted optical signal into the receiver unit; and
a demodulator unit configured to receive the transmitted optical signal and a reference optical signal and generate a demodulated electrical signal comprising the in-phase component and the quadrature component.

2. The optical interconnect of claim 1, wherein the transmitter unit further comprises:
a first digital signal processor configured to receive one or more input data signals and to generate one or more DSP signals representing the in-phase component and the quadrature component; and
one or more first digital-to-analog converters configured to receive the one or more DSP signals from the first digital signal processor and to generate one or more analog control signals for driving the modulator unit.

3. The optical interconnect of claim 2, wherein the receiver unit further comprises:
one or more first analog-to-digital converters configured to receive the demodulated electrical signals and to generate one or more demodulated digital signals; and
a second digital signal processor configured to receive the one or more demodulated digital signals and to generate one or more output data signals representing the one or more input data signals.

4. The optical interconnect of claim 1, wherein the modulator unit comprises nested Mach-Zehnder interferometers and a quadrature phase-shifter.

5. The optical interconnect of claim 1, wherein the modulator unit comprises nested ring modulators and a quadrature phase-shifter.

6. The optical interconnect of claim 1, wherein the first optical coupler and the second optical coupler comprise optical grating couplers, and wherein the transmitted optical signal propagates out-of-plane from the surface of the transmitter unit at a substantially normal direction from the surface of the transmitter unit.

7. The optical interconnect of claim 1,
wherein the transmitter unit further comprises a second modulator unit configured to modulate the source optical signal and to generate a second modulated optical signal comprising a second in-phase component and a second quadrature component,
wherein the transmitted optical signal further comprises the second modulated optical signal, and
wherein the receiver unit further comprises a second demodulator unit configured to receive the transmitted optical signal and the reference optical signal and generate a second demodulated electrical signal comprising the second in-phase component and the second quadrature component.

8. The optical interconnect of claim 7, wherein the first optical coupler and the second optical coupler comprise latticed grating couplers having two inputs.

9. The optical interconnect of claim 1, wherein the reference optical signal is generated by the receiver unit.

10. The optical interconnect of claim 1, wherein the reference optical signal is generated by the transmitter unit.

11. The optical interconnect of claim 1, wherein the modulated optical signal represents a phase-shift-keying (PSK) modulated signal.

12. The optical interconnect of claim 1, wherein the modulated optical signal represents a quadrature amplitude modulation (QAM) modulated signal.

13. The optical interconnect of claim 1, further comprising an optical cable that is optically coupled to the first optical coupler of the transmitter unit and the second optical coupler of the receiver unit.

14. The optical interconnect of claim 13, wherein the optical cable comprises one or more single-mode fibers or one or more polarization maintaining fibers.

15. The optical interconnect of claim 13, wherein one end of the optical cable is co-packaged with the transmitter unit via a first fiber array having multiple fibers, and another end of the optical cable is co-packaged with the receiver unit via a second fiber array having multiple fibers.

16. The optical interconnect of claim 1, wherein the modulator unit and the first optical coupler are integrated in a silicon substrate.

17. The optical interconnect of claim 16, wherein the laser device is bonded to the silicon substrate.

18. A computing system comprising:
a first processor element;
a second processor element;
an optical interconnect configured to provide data communications between the first processor element and the second processor element, the optical interconnect comprising:
a transmitter unit comprising:
a laser device configured to generate a source optical signal;
a modulator unit configured to modulate the source optical signal and to generate a modulated optical signal comprising an in-phase component and a quadrature component; and
a first optical coupler configured to couple a transmitted optical signal comprising the modulated optical signal out of the transmitter unit,
wherein the source optical signal and the modulated optical signal propagate in-plane along a surface of the transmitter unit, and wherein the transmitted optical signal propagates out-of-plane from the surface of the transmitter unit; and
a receiver unit comprising:
a second optical coupler configured to couple the transmitted optical signal into the receiver unit; and
a demodulator unit configured to receive the transmitted optical signal and a reference optical signal and generate a demodulated electrical signal comprising the in-phase component and the quadrature component.

19. The computing system of claim 18, wherein the first processor element, the second processor element, and the optical interconnect are co-packaged on a common substrate.

20. The computing system of claim 18, wherein each of the first processor element and the second processor element comprises one or more of a graphics processing unit (GPU), a central processing unit (CPU), a neural network processing unit (NPU), or a tensor processing unit (TPU).
